(19) United States
(12) Patent Application Publication
(10) Pub. No.: US 2004/0260456 A1
(43) Pub. Date: Dec. 23, 2004

(54) Method of processing a navigation signal containing data

(76) Inventors: Nicolas Martin, Bourg-Les-Valence (FR); Blandine Coatantiec, Bourg-Les-Valence (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/494,259

(22) PCT Filed: Dec. 13, 2002
(86) PCT No.: PCT/FR02/04349

(30) Foreign Application Priority Data
Dec. 18, 2001 (FR) 01/16397

(51) Int. Cl. G01C 21/26

(52) U.S. Cl. 701/200; 701/214

(57) ABSTRACT

The invention relates to methods of processing satellite navigation signals which also support data.

It consists in using two nested carrier loops, one comprising an extended discriminator of DBPSK differential type (115) to cope with the dynamic range, and the other a nonextended discriminator of BPSK type (117) so as not to correlate the code errors.

It makes it possible to use a much higher data transmission speed requiring the use of a “Viterbi” type algorithm.

The present invention relates to methods of processing navigation signals when the latter furthermore comprise one or more additional modulations making it possible to convey data which will supplement the information intrinsically contained in the elementary signal. It applies more particularly to the processing of navigation signals transmitted by satellites.

The satellite radio navigation currently essentially uses the signals transmitted by the GPS system, and subsidiarily those of the GLONASS system. In the future it will use the signals of the GALILEO system. This radio navigation makes it possible to obtain the position of the receiver by processing the signals transmitted by at least three satellites and by performing phase measurements and code measurements on these signals. The code measurements are rather inaccurate but unambiguous, while the phase measurements are much more accurate but ambiguous.

The signals transmitted by the satellites contain data bits which make it possible to convey navigation messages. These messages are used in the calculation algorithms to determine the position, the speed and the time of the receiver.

In the currently used systems, of the GPS type, a data rate of the order of 50 baud is used, this making it possible on the one hand to extract without too much difficulty these data from the signal received, whose level is very low, and on the other hand not to disturb the main navigation signal.

Moreover, in view of the optimization thus chosen, it is not necessary to use an error correcting system and consequently each bit conveyed corresponds to a useful bit.

In the future systems currently being studied, of the GALILEO type, one would like to convey much more data, thus implying the use of a bit rate of around 1000 baud.

Under these conditions the error rate increases considerably, thereby requiring the use of an error correcting code. Provision is therefore made to use a system of the so-called “Forward Error Corrector” type, comprising a level 2 redundancy and a level 7 convolution. The error correction would then be made with for example a Viterbi type algorithm, for which it is known that, in order to operate correctly, it requires the errors to be uncorrelated. So, to demodulate the signal received so that the data rate does not overly disturb the demodulation of the navigation signal, a differential discriminator of the type known by the name DBPSK needs to be used. To demodulate the information corresponding to a bit, such a discriminator uses the information corresponding to the demodulation of the previous bit, hence the qualifier “differential”.

Under these conditions, the phase received rotates and it is then necessary to use an integration system, that makes it possible to obtain feedback control to this phase.

Moreover, in an DBPSK type differential demodulator, use is made of the difference in signs from one sample to the next to determine the value of the data bit received. Since the signal is noisy, this implies that the error in a bit depends on the value of two successive samples. Under these conditions the error is no longer uncorrelated and the Viterbi algorithm does not operate.

To be able nevertheless to obtain the data with a sufficiently low error rate, while retaining correct reception of the navigation signals, the invention proposes a method of processing a navigation signal containing data, in which method a first carrier loop of DBPSK type is used to demodulate the navigation signals, characterized in that a second loop of BPSK type is furthermore used to identify the data tests.

Other features and advantages of the invention will become clearly apparent in the following description, presented with regard to the appended figures which represent:

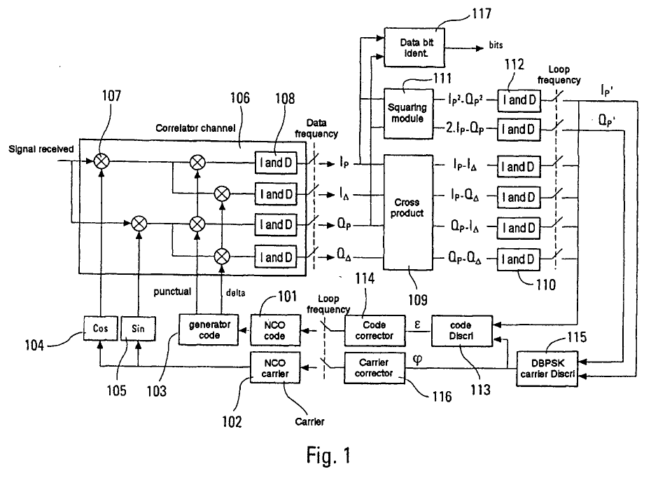

FIG. 1, an overall diagram of the architecture of the loops used in the method according to the invention;

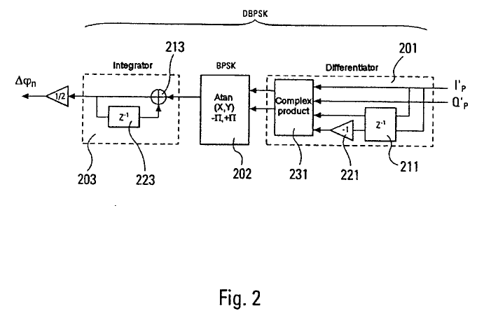

FIG. 2 a diagram of the carrier discriminator; and

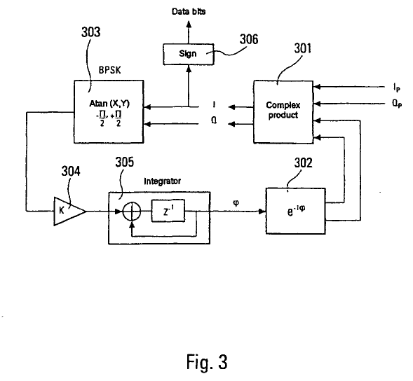

FIG. 3, a diagram of the code discriminator.

In the diagram of the decoder represented in FIG. 1, the code oscillator 101 and carrier oscillator 102 are controlled by the error signals which are described later. They make it possible to obtain respectively a punctual code and a Δ code in a generator 103 and sin. and cos. signals in phase shifters 104 and 105.

The punctual, Δ, cos. and sin. signals are applied to a correlator 106 which on the basis of the signal received makes it possible to obtain the signals Iₚ, I_{Δ}, Qₚ and Q₆₆ in a conventional manner with the aid of a set of multipliers 107 and of sample-and-hold units 108.

For the subsequent processing these signals are sampled at a data frequency.

According to the invention, to be able simultaneously to maintain the performance of the demodulation loops both in terms of dynamic range and robustness and to correctly decode the data signals and let the Viterbi algorithm operate, use is made of two demodulators, a first demodulator of DBPSK type for the carrier and a second demodulator of DBPSK type for the data.

In the first loop the signals sampled at the output of the correlator 106 are multiplied together in a module 109 to obtain cross products Iₚ·I₆₆, Iₚ·Q_{Δ}, Qₚ·I_{Δ}and Qₚ·Q_{Δ}. These cross products are integrated in a set of integrate-and-hold circuits 110, so as to then obtain the variables A, B, C and D defined by the formulae:

A=ΣIₚ·I_{Δ} (1)

B=ΣIₚ·Q_{Δ} (2)

C=ΣQₚ·I_{Δ} (3)

D=ΣQₚ·Q_{Δ} (4)

According to the invention, the signals Iₚ and Qₚ are subjected to a so-called “squaring” processing, which consists in calculating a complex product Iₚ×iQₚ. This eliminates the data, and hence their influence, and still introduces quadratic losses and multiplies the dynamic range of the signal by two. This operation makes it possible to lift the limitation of the predetection band originating from the data bits. It is performed in a complex squaring module 111 which therefore delivers the two signals I′ₚ=Iₚ²−Qₚ² and Q′ₚ=2 Iₚ×Qₚ. These signals are themselves integrated in a second set of integrate-and-hold units 112.

The six signals thus obtained by the above operations are sampled at a loop frequency, then they are combined together in a code discriminator 113 to obtain a signal ε determined by the formula:

ε=(cos² φ·A+cos φ·sin φ·B+sin φ·cos φ·V+sin²φ·D)/\sqrt{I′²ₚ+Q′²ₚ} (5)

this operation makes it possible to obtain a gain of 3 dB in the accuracy of the code.

The signal ε is then applied to a code corrector 114 which performs a conventional filtering operation. After sampling at the loop frequency this filtered signal ε forms the error signal applied to the input of the code oscillator 101.

Moreover the signals Iₚ′ and Qₚ′ originating from the “squaring” are applied to the carrier discriminator of type DBPSK 115 which will be described later.

The signal φ originating from this discriminator 115 is applied on the one hand to the code discriminator 113, and on the other hand to a carrier corrector 116, which likewise performs a simple known filtering operation.

The signal φ is thus filtered and then sampled at the loop frequency to form the error signal of the carrier oscillator 102.

In an exemplary embodiment of the DBPSK type carrier discriminator, the diagram of which is represented in FIG. 2, the signals Iₚ′ and Qₚ′ are first applied to a differentiator 201.

In this differentiator, a facility 211 performs the Z⁻¹ transform of these signals Iₚ′ and Qₚ′. The two signals originating from this transform are applied, after multiplication by −1 in the case of one of them in a multiplier 221, to a complex product calculator 231, which also receives the signals Iₚ′ and Qₚ′ directly.

The signals output by this differentiator are then applied to a BPSK type discriminator 202 which performs the operation arc tangent (x,y) in an interval −π+π.

The output from this discriminator 202 is then applied to an integrator 203, which operates in a conventional manner with a summator 213 and a Z⁻¹ function generator 223.

Δφₙ, which lies between −90 and +π, is thus measured and Δφₙ₊₁ is then obtained through the formulae:

$$\begin{matrix}{Δϕ}_{n + 1} = argument ( {I}_{n + 1} + {iQ}_{n + 1} ) \cdot - argument ( {I}_{n} + {iQ}_{n} ) \\ = argument ( {I}_{n + 1} + {iQ}_{n + 1} ) \cdot / ( {I}_{n} + {iQ}_{n} ) \\ = argument ( {I}_{n + 1} + {iQ}_{n + 1} ) \cdot ( {I}_{n} - {iQ}_{n} )\end{matrix} \qquad ( 6 )$$

According to the invention, the identification of the data bits is done in an identifier 117 on the basis of the signals Iₚ and Qₚ provided by the correlator 106. This identifier operates on the basis of a BPSK type discriminator.

The phase discrimination is therefore then bounded between −π and +π and the time constant Te/K is chosen to be sufficiently small to uncorrelate the successive bit errors.

The drawback of this procedure is that it copes less well with the dynamic range, this being amply offset by the fact that the Viterbi algorithm can operate correctly.

In an exemplary embodiment, represented in FIG. 3, the signals Iₚ and Qₚ are applied to a complex multiplier 301, which also receives the signals output by a module 302 which will be described later.

The signals I and Q originating from this complex conduit are then applied to a discriminator 303 of the BPSK type, which performs the operation arc tangent (x,y) on a signal bounded between −π/2 and +π/2.

The output signal from this discriminator is multiplied by a constant K in an amplifier 304, then it is applied to an integrator 305 in the structure is identical to that of the integrator 203 of FIG. 2. The signal φ output by this integrator is applied to the module 302 which performs the operation e^{-1φ} to give the signals envisaged above.

The data bits are then obtained by determining with the aid of a comparator circuit 306 the sign of the signal I output by the complex product generator 301.

1. A method of processing a navigation signal containing data, in which method a first carrier loop (101,102,103,104,105,106,113,114,115,116) of DBPSK type is used to demodulate the navigation signals, characterized in that a second loop of BPSK type (117) is furthermore used to identify the data bits.

2. The method as claimed in claim 1, characterized in that a “squaring” technique (111) is used in the first carrier loop.

3. The method as claimed in claim 2, characterized in that a correlation (106) is performed on the signal received to obtain signals Iₚ, I₆₆, Qₚ and Q_{Δ}, in that cross products (109) defined by the formulae:
A=ΣIₚ·I_{Δ}
B=ΣIₚ·Q_{Δ}
C=ΣQₚ·I_{Δ}
D=ΣQₚ·Q_{Δ}
are performed on these signals, in that the “squaring” technique makes it possible to obtain signals Iₚ²−Qₚ² and 2 Iₚ·Qₚ, and in that a code discrimination (113) is performed on the basis of the cross products and of the signals obtained by the “squaring” by performing the operation given by the formula:
ε=(cos²φ·A+cos φ·sin φ·B+sin φ·cos φ·V+sin²φ·D)/\sqrt{I′²ₚ+Q′²ₚ}
